(19) United States
(12) Patent Application Publication
(10) Pub. No.: US 2004/0216550 A1
(43) Pub. Date: Nov. 4, 2004

(54) Electronic throttle control system for motorcycles

(76) Inventors: Klaus Fallak, Werne (DE); Carmelo Leone, Neufahrn (DE)

Correspondence Address: MILDE & HOFFBERG, LLP, 10 BANK STREET, SUITE 460, WHITE PLAINS, NY, 10606, US

(21) Appl. No.: 10/816,669

(22) Filed: Apr. 2, 2004

(30) Foreign Application Priority Data
Apr. 4, 2003 (DE) 103 15 448.5

(51) Int. Cl. B62K 21/26

(52) U.S. Cl. 74/551.9

(57) ABSTRACT

An electronic throttle device 10 for motorcycles is mounted on a handlebar. A twist grip 16 may be rotated from an idle position to the full-throttle position. A rotation-position sensor 104 with a rotor unit and a stator unit is either mounted along the rotation axis of the twist-throttle control element 16 or outside of it. In the former case, an intermediary coupling unit 50 is provided that is fixed both to the twist-throttle control element 16 and to the rotor unit 46, 74 to rotate with them. In the latter case, an engagement element 92 is provided for coupling with a first toothed area 94 that engages with a toothed element 96 with a second toothed area 98. A Hall-effect rotation sensor or inductive rotation sensor is preferably used as a rotation-position sensor, whereby in the former case a rotor unit 46, 106 may be moved across from a stator unit 44, 108 with two stator partial elements 58a, 58b. In the latter case, an inductive coupling element 78 is mounted on the rotor unit 74, and an induction circuit 80 is mounted on the stator unit 76.

Invention relates to an electronic throttle system device for motorcycles that is mounted on a handlebar.

In motorcycles, a twist grip on the handlebar is used for throttle control. Although the position of the twist grip on a conventional motorcycle directly determines the position of the throttle plate via Bowden cable, electronic throttle control, or, so-called “drive by wire”, systems are being considered for use for motorcycles as in automobiles.

An electronic throttle control system device for motorcycles, known from DE-A-195 47 408, is mounted on a handlebar element. An adjustable twist grip is provided on the handlebar element as a twist throttle control. A Hall angular sensor, rotational potentiometer, optical rotational-angle sensor, capacitive sensor, or inductive sensor is included as a rotational-position sensor within the twist grip. The sensor signal is evaluated within a control unit. By means of the control unit, a suitable opening angle of the engine throttle plate is dictated that corresponds to the position of the twist grip. It has been shown, however, that mounting a rotation-position sensor within the twist grip is disadvantageous for operation and installation. The main drawback is that the twist grip must be too thick because of the sensor contained within it.

A bicycle with engine is described in DE-U-8717587. Engine control is via a twist grip whose angular position is sensed by a potentiometer. The potentiometer may be located within the twist grip or adjacent to it. In the latter configuration, the rotational motion of the grip is transferred to the potentiometer by means of conical gears.

US-B-6276230 also describes an electronic throttle control system. A twist grip of the vehicle is affixed to a handlebar tube so that it may rotate. A rotational sensor is provided to recognize the position of the twist grip. A mechanical coupling element (not described further) is positioned between the twist grip and the sensor. From it extend projections that engage with the twist grip and hold it so it may not rotate. The mechanical coupling element includes a device to limit the rotational angle, a spring element to return the twist grip, and the rotational sensor.

In the design shown in which the sensor is obviously located along the rotational axis within the twist grip, the problem arises that, upon operation of the twist grip, potentially-occurring oblique loads may be passed along by the sensor, which may lead on the one hand to mechanical loads and, on the other, to an inexact measurement-value determination.

EP-A-13358 502 discloses a throttle control system device for two-wheeled vehicles. The position of a twist grip is determined via a rotational sensor. Toothed gears are provided to transfer the rotational movement of the grip to the sensor. A spiral spring serves as the return element for the gear wheel connected to the twist grip. A spring-loaded friction ring is further provided on the gear wheel to provide counter-force.

In the design shown, engagement of the gear wheels must be of high precision for exact control, so that the device is correspondingly expensive.

JP-A-04254278 provides a further example of a twist throttle. Here, a twist grip is mounted on a handlebar so that it may rotate. A Bowden cable is coupled with the grip unit via a cable-guide element. A sensor gear wheel of a rotational sensor is coupled with the twist grip via a gear arrangement.

With regard to a throttle control system device in which a rotation-position sensor is positioned outside the rotational axis of a twist-throttle control element, it is a first objective of the present invention to provide a design that allows exact control at low cost.

This task is solved by a device per Patent Claim 1. Advantageous embodiments are given in the Dependent Claims.

Regarding a throttle control system device in which the rotation-position sensor is essentially mounted along the rotational axis of the twist-throttle control element, it is a second objective of the present invention to reduce the effects of potential oblique loads.

This task is solved by a device per Patent Claim 7. Advantageous embodiments are given in the Dependent Claims.

Finally, it is yet a third objective of the present invention to provide a throttle control system device by means of which a very accurate sensor signal is achieved. This further task is solved by means of electronic throttle control system devices per Claims 23 and 25. Dependent Claims refer to advantageous embodiments of the invention.

For the achievement of the first objective per Patent Claim 1 with an electronic throttle control system device with twist-throttle control element (e.g., a twist grip) and a rotation-position sensor (preferably an inductive or Hall-effect rotation sensor), in which the rotation-position sensor is positioned outside the rotational axis of the twist-throttle control element, and whose rotor unit is coupled with the twist-throttle control element via the first teeth of an engaging element and the second teeth of a toothed element, a return element is so coupled with the rotor unit that the engagement between the first and second teeth occurs essentially without play.

By means of such a return element—e.g., a spring element acting on the rotor unit—the rotor element is loaded with respect to the rotation-position sensor with a force or torque. Thus, the coupling is also no longer without force via the engaging element, so that free play at this location is avoided.

The invention starts with the knowledge that, in throttle control system devices according to the state of the art in which gear wheels are used to provide engagement of twist-throttle control element and rotation-position sensor, this coupling is largely without force. Here, mechanical play occurs at the engagement element, which has a very negative effect on the exactitude of determination of rotation position of the twist-throttle control element, thus leading to inaccurate control. By use of the return element based on the invention that works on the rotor unit, this disadvantage is overcome in a particularly simple fashion.

The invention provides for the rotation-position sensor to be so shaped and positioned that the rotation axis of the rotor unit extends parallel to the rotation axis of the twist-throttle control element, but at a distance from it. This configuration has proven to be particularly suitable with respect to spatial relationships, and altogether leads to a unit with short axial length.

The return element based on the invention is so positioned that it acts against the actuation direction of the twist-throttle control element. For this, the actuation direction is the direction from idle to full throttle. It is particularly advantageous for the return element to be so positioned that force acts on the rotor unit in the idle position, i.e., when the spring is compressed.

Several return elements could basically be used on a throttle control system device to return the twist-throttle control element against the actuation direction. A spring element, especially a helical spring, is preferably used as a return element. Such a spring element may be positioned on the twist grip, on an engagement element, or on the rotation-position sensor. The use of several spring elements is also possible. It is particularly advantageous to use the spring element on the rotor unit as the only return element.

The return element on the rotor unit based on the invention may basically have any shape. It is preferable on the one hand to form it as a spiral spring positioned about the rotation axis of the rotor unit, and on the other hand to use a pull cable that acts on the rotor unit. A spiral spring requires very little space. A pull cable may be attached, for example with one end on a draw spring and the other on the rotor unit. Upon rotation of the rotor unit, the cable may at least partially roll up onto a cable guide element. With such a configuration, there is a high degree of configuration flexibility, since the actual spring may be affixed to almost any point, even at some distance from the rotor unit. Additionally, considerable forces adequate for the return of the entire system may be easily applied using such a pull cable. Also, a desired pre-defined force progression (Force/Path characteristic curve) may be easily adjusted in this manner.

Based on a further development of the invention, the engagement element may additionally serve as the coupling of the twist-throttle control element with the rotor unit positioned along the rotation axis of the twist-throttle control element, and may rotate with it. Additionally, an axial bearing is provided for the engagement element in order to maintain an axial position in which engagement is ensured.

In the achievement of the second objective based on the invention per Claim 7, the rotation-position sensor is positioned axially adjacent to the twist-throttle control element, whereby the rotation axis of the rotor unit is essentially identical with the rotation axis of the twist-throttle control element. Based on the invention it is recommended that the rotation-position sensor be configures as an intermediary coupling unit between the twist-throttle control element and the rotor unit. The intermediary coupling unit is firmly connected both with the twist-throttle control element and with the rotor unit. The coupling, however, is so shaped that any occurring oblique loads are not transferred.

Upon use of a twist grip, considerable forces may partially arise in an oblique direction to the handlebar. The intermediary coupling unit based on the invention prevents such oblique loads from the twist-throttle control element from being transferred to the rotation-position sensor that may lead to inaccuracy or even wear and damage.

The intermediary coupling unit, however, is firmly attached with both elements positioned with it so that the rotation motion is essentially transferred without free play.

Use of an element for configuration of the intermediary coupling unit is recommended that, at least to some degree-allows inclination with respect to the units connected with it. The rotation motion is preferably still transferred essentially with no free play, quasi in the form of a universal joint.

Based on a development of the invention, the intermediary coupling unit is essentially disk-shaped with axial engagement projections. For this, at least two engagement projections are directed toward the rotor unit, and at least two other engagement projections are directed toward the twist-throttle control element, and engage into corresponding recesses that are axially displaceable to create a rotation-free connection there. It is particularly preferred for the intermediary coupling unit not to be supported on bearings but rather mounted free between the axially adjacent units. With such an essentially disk-shaped intermediary coupling unit, the function described above may be realized in a particularly simple and space-saving manner.

In the following, expanded embodiments of the invention will be provided that may be used for electronic throttle control system device based on either Patent Claim 1 or 7.

A return element may advantageously be formed using a spring-loaded pull cable attached to a cable guide element that is essentially ring-shaped. The cable guide element is coupled with the rotor unit or with the twist-throttle control element so that it may not rotate. The cable guide element includes at least one wedge-shaped cross-section cable guide slot into which the cable is inserted. When the twist-throttle control element is actuated, the cable is placed into the cable guide slot. The wedge shape allows achieval of a desired degree of friction of the pull cable. This may be increased by the use of a friction-increasing insert in the slot. The corresponding friction force may be felt by the user upon actuation of the twist-throttle control element, and is shown in the Force/Path characteristic curve as hysteresis. Suitable adjustment of this friction force, preferably supported by suitable selection of spring characteristic curve and suitable radial extension of the cable guide slot, allows very flexible adjustment of the desired Force/Path characteristic curve.

In principle, any type of known rotation sensor may be used for the rotation-position sensor. A Hall-effect rotation sensor element on the one side, and an inductive rotation sensor on the other, is particularly advantageous.

In a Hall-effect rotation sensor element, a magnetic element is preferably mounted on the rotor unit. The stator unit consists of two opposing stator component elements between which at least one separation recess is positioned. A Hall-effect element is positioned in at least one separation recess that preferably consists of a Hall ASIC element. Upon rotation of the rotor unit, the magnetic element causes an alteration of the magnetic flux within the stator unit. This is measured in the air gaps by at least one, and preferably two, Hall-effect elements. This allows determination of the rotation position of the rotor unit with respect to the stator unit.

In a advantageously specially-shaped Hall-effect rotation sensor element, the stator units are shaped as part of a ring. A first stator ring element extends within an angular range of from 100° to 140°, and a second stator ring element within an angular range of from 220° to 260°. The angle values expressed as length here designate the width of the angle range (as a portion of a 360° full circle) over which the elements extend. Such a sensor is especially suited for the determination of a rotation angle between 0° and 120°, as is required on a twist grip. It is further advantageous for the magnetic element to be formed as a partial ring magnet segment element, and include a length of from about 100° to 150°. Details of a general Hall-effect rotation sensor that is not specially adapted for use as a rotation-position sensor in a throttle-control system based on the invention may be taken from DE-A-19716985 by the Applicant.

The alternatively preferred inductive rotation sensor includes an inductive coupling element on the rotor unit, and an inductor circuit with at least two inductors on the stator unit. The inductive coupling of the two inductors is dependent on the position of the coupling elements. It is again preferred that the inductor circuit is shaped as a portion of a ring encompassing an angle range of between 100 and 140° of a full circle. An inductive coupling element with a resonance circuit with at least one inductor and one capacitor is especially preferred. Details regarding such a sensor are described in WO-A-2003038379. The linear position sensor shown here is turned into a rotation sensor by a ring-shaped, or partial-ring-shaped, induction circuit.

In the achievement of the third objective according to the invention based on the invention and described in Patent Claim 23, independent of whether the rotation-position sensor is positioned in the rotation axis of the twist-throttle control element or at a distance from it, a Hall-effect rotation sensor is provided as was described above. A first stator ring element is 100 to 140° long, and a second stator ring element is 220 to 260°. The rotor unit preferably includes a partial-ring-shaped magnet segment element of a length of from 100 to 150° that is positioned on a magnet mounting element.

The recommended sensor is specially adapted for use on a throttle twist grip, and offers a high degree of accuracy and resolution in the pertinent angle range.

In further achievement of the third objective, based on the invention per Claim 25, again independent of rotation-position sensor position, a special inductive sensor is provided. It is specially adapted for use on a throttle twist grip, and offers a high degree of accuracy and resolution in the pertinent angle range. For this, the induction circuit is partial-ring-shaped, and it extends over an angle range of 100-140°.

In the following, embodiment examples of the invention are described in greater detail using Illustrations, which show:

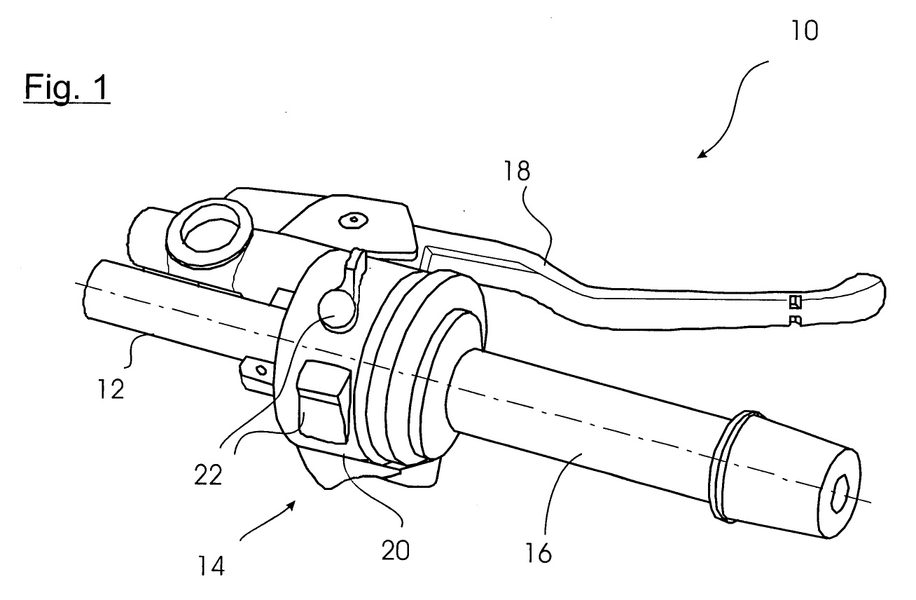

FIG. 1 A general electronic throttle control system for motorcycles in a schematic, perspective view;

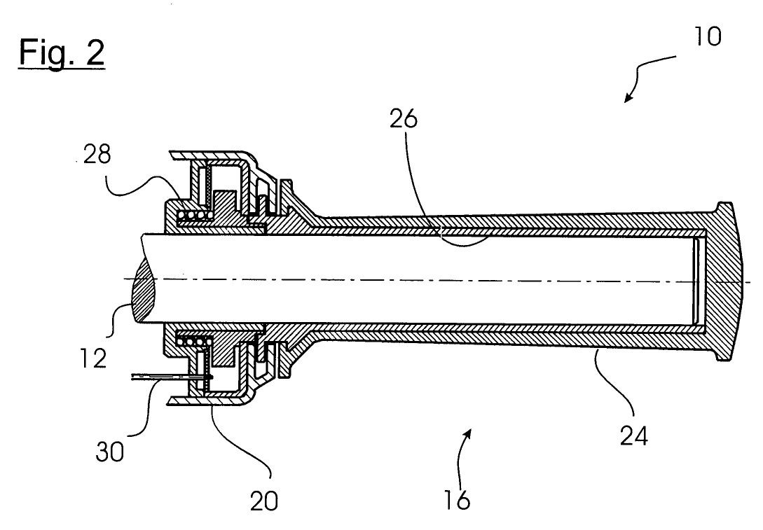

FIG. 2 The general electronic throttle control system in FIG. 1 in a schematic cutaway view;

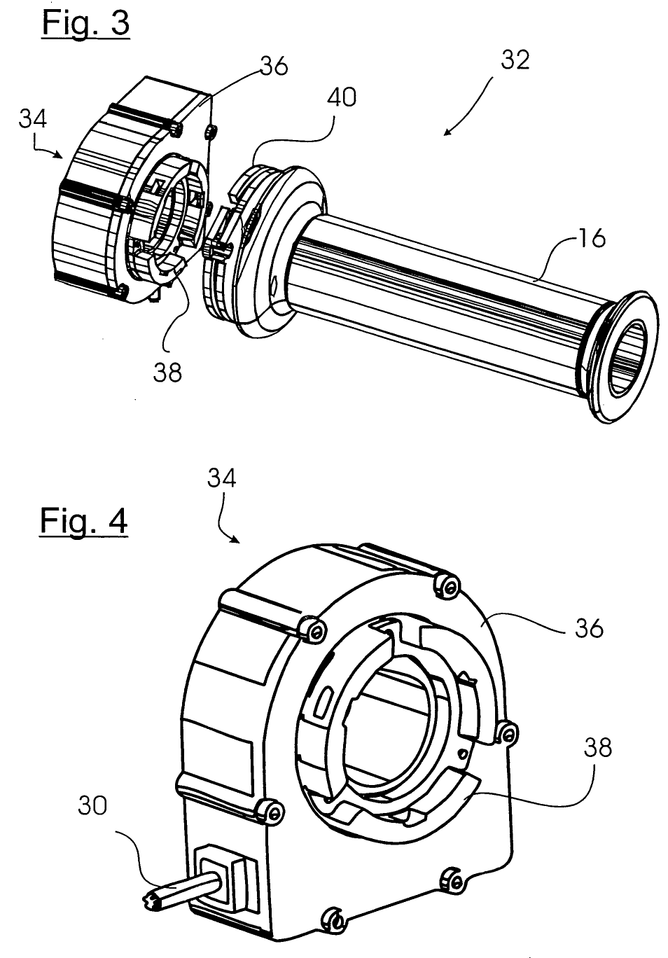

FIG. 3 Parts of a first embodiment example of an electronic throttle control system in perspective view;

FIG. 4 A sensor unit of the throttle control system in FIG. 3 in perspective view;

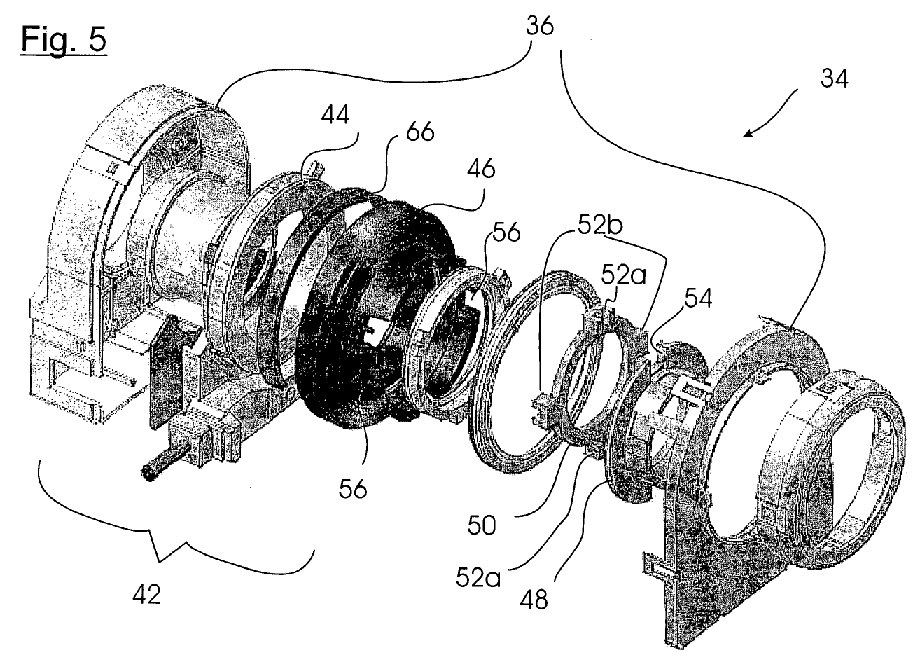

FIG. 5 Parts of the sensor unit in FIG. 4 in a perspective exploded view;

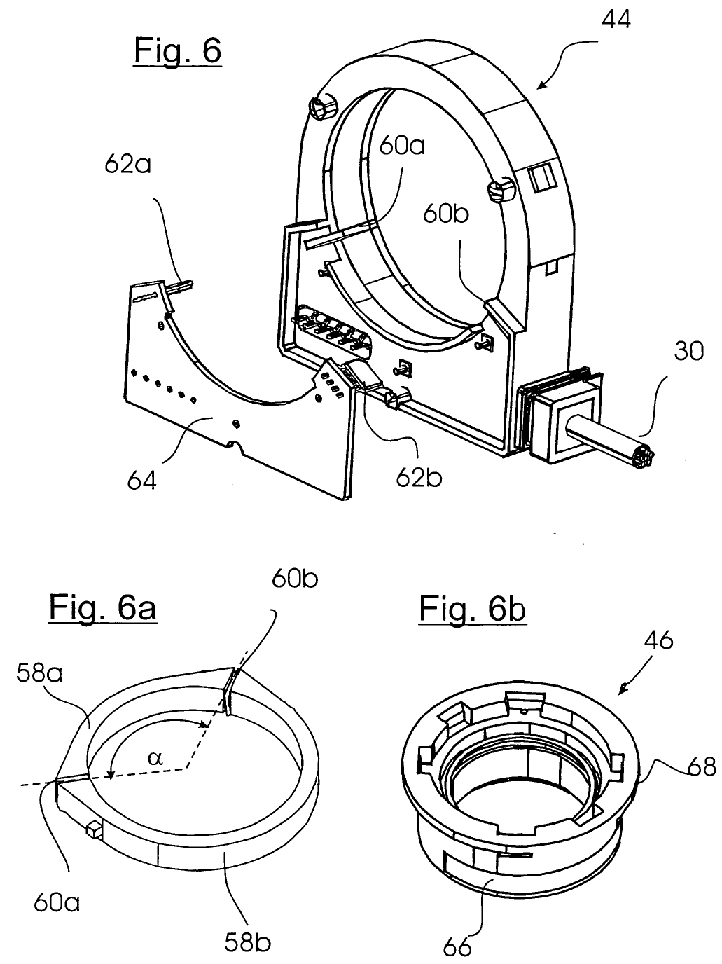

FIG. 6 Parts of a stator unit of an inductive sensor of the sensor unit in FIGS. 4, 5 in a perspective exploded view;

FIG. 6a Stator elements of the stator unit in FIG. 6 in perspective view;

FIG. 6b A rotor unit of the inductive sensor in FIG. 5 in perspective view;

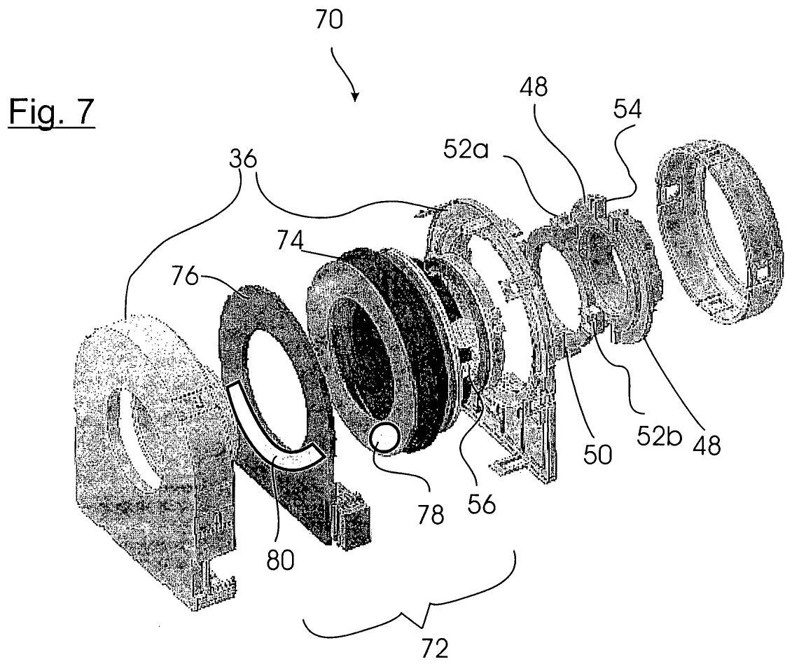

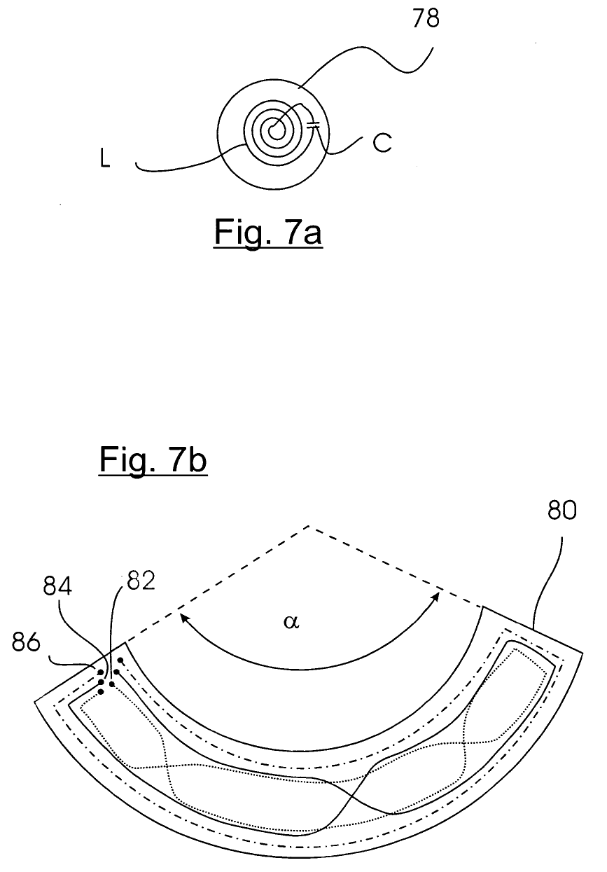

FIG. 7 A second embodiment example of a sensor unit with inductive sensor in perspective view;

FIG. 7a An inductive coupling element of the inductive sensor in FIG. 7;

FIG. 7b An inductive circuit of the inductive sensor in FIG. 7;

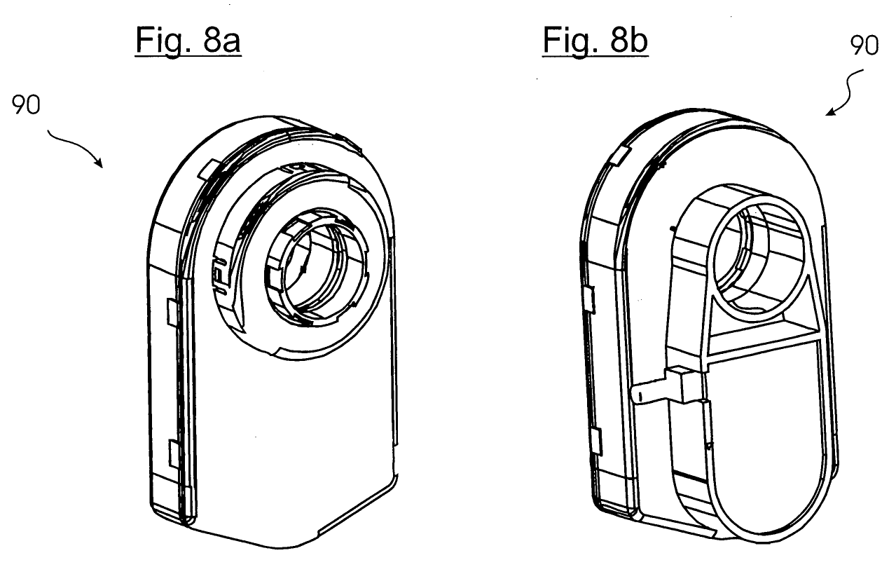

FIG. 8a A frontal perspective view of a third embodiment example of a sensor unit;

FIG. 8b A rear perspective view of the sensor unit in FIG. 8a;

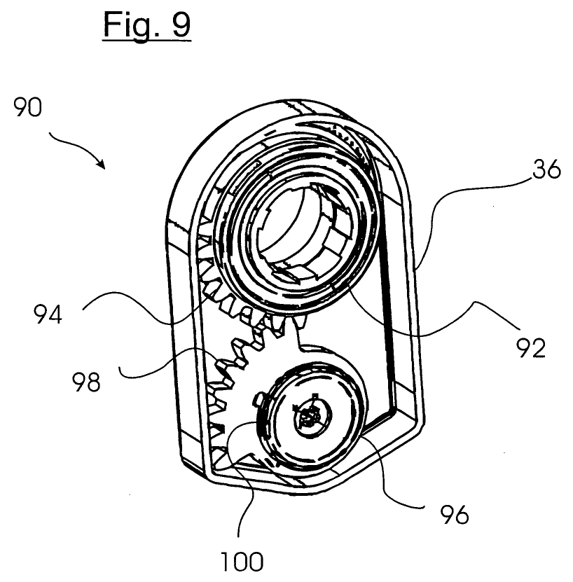

FIG. 9 An opened sensor unit in FIG. 8 in perspective view;

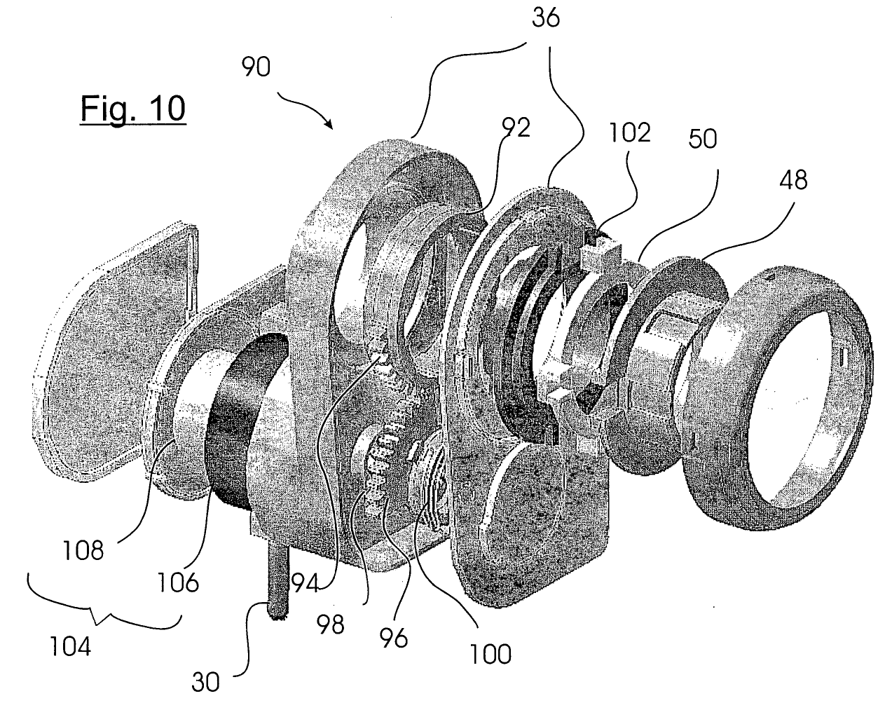

FIG. 10 The sensor unit in FIG. 8a, 8b in an exploded perspective view;

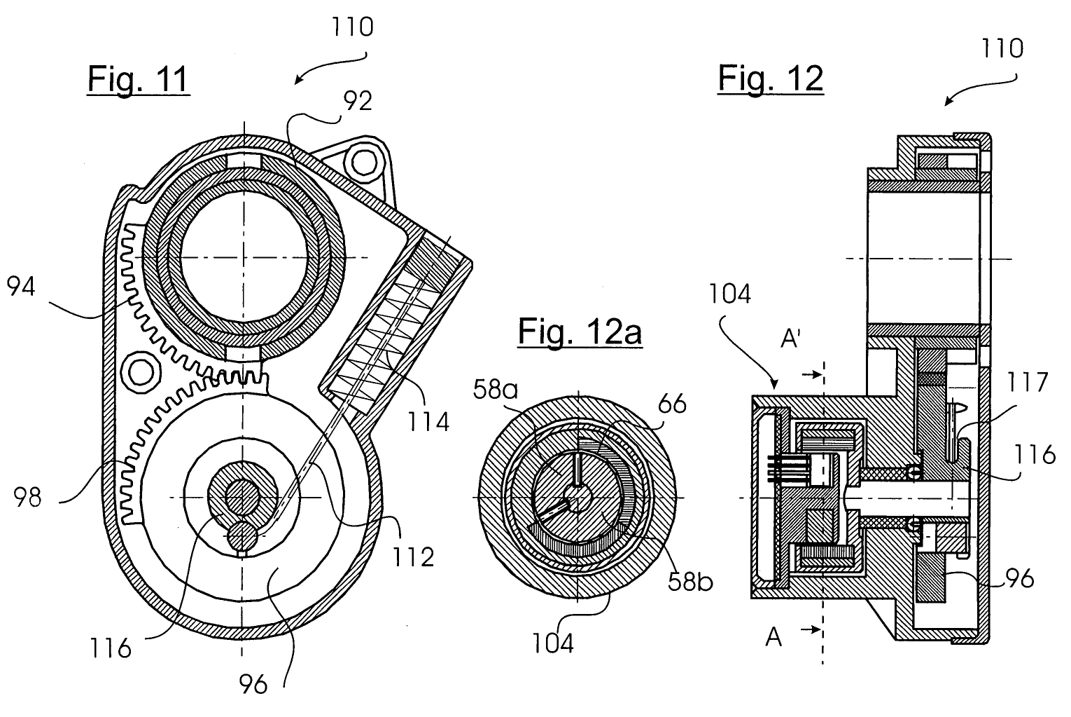

FIG. 11 View of a cross-section through a fourth third embodiment example of a sensor unit with pull cable spring;

FIG. 12 A longitudinal cross-section of the sensor unit in FIG. 11;

FIG. 12a A cross-sectional view along projection A . . . A′ in FIG. 12;

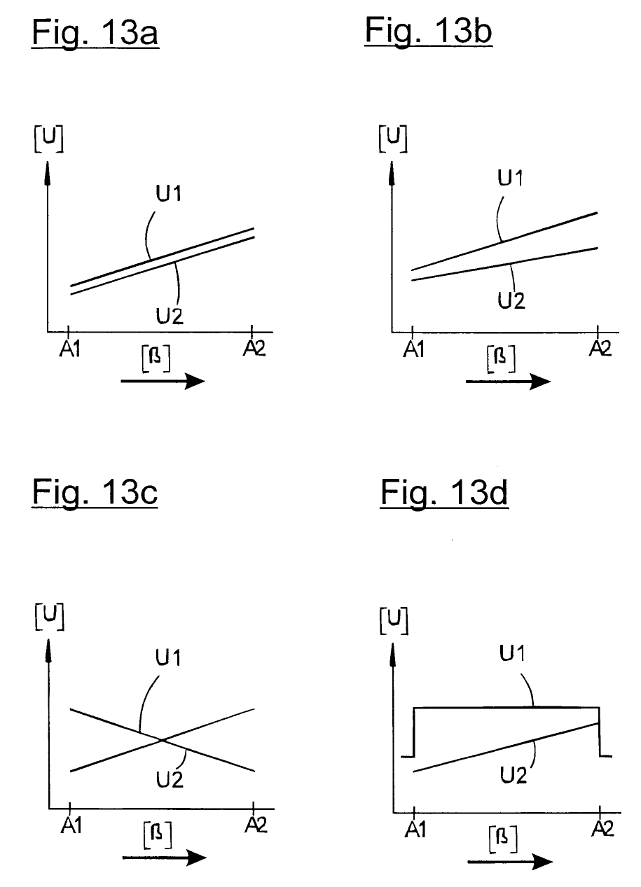

FIG. 13a-13d Various initial characteristic curves of a rotation-position sensor;

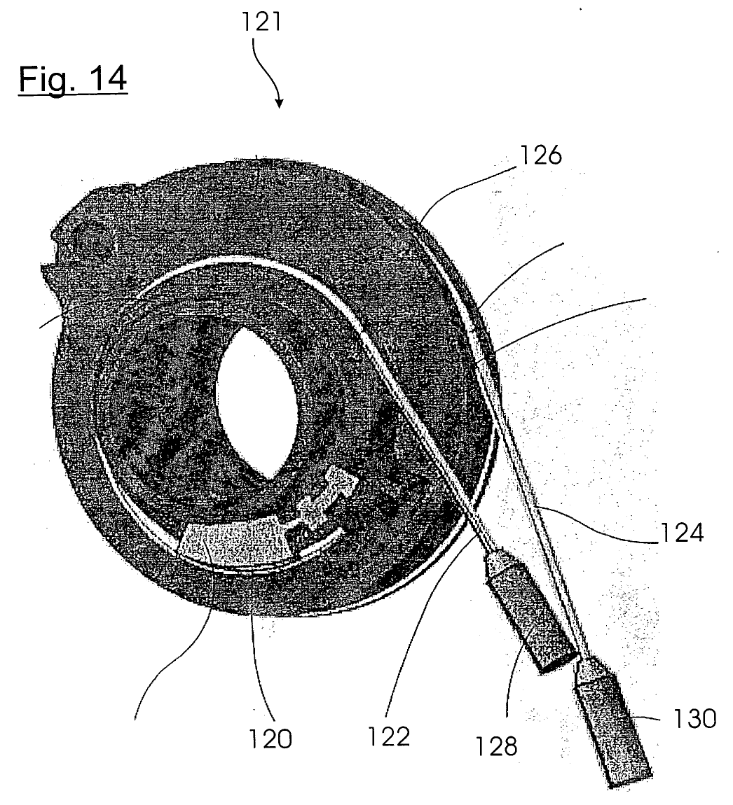

FIG. 14 A perspective view of a return element.

FIG. 1 shows a general throttle control system 10 for a motorcycle. A hand actuation unit 14 with a twist grip 16, a hand lever 18, and a function element housing 20 with functional elements 22 is mounted on the right end of a handlebar 12 that is only partially shown in FIG. 1. The throttle is opened by the hand surrounding and rotating the twist grip 16 serving as a twist-throttle control element. The functional elements 22 and the hand lever 18 are also operated by the same hand. Although the hand actuation unit 14 in the illustrated example is mounted on the right end of the handlebar tube 12, it could also be on the left end in another embodiment example.

The electronic throttle control system 10 does not possess a conventional Bowden cable to adjust the throttle plate, but rather the position of the twist grip 16 is determined by means of a sensor and is further processed as an electrical signal. The twist grip may be rotated from an idle position along the actuation direction to the full-throttle position.

As the cutaway view in FIG. 2 shows, the twist-throttle control element 10 consists of an outer rubber boot 24 that is drawn over a bearing bushing 26. The bearing bushing 26 is mounted on the handlebar 12 so that it may rotate. The functional element housing 20 is positioned axially adjacent to the twist-throttle control element 16 within which a return spring unit (here in the form of a helical spring) and a position sensor for the position of the twist-throttle control element 16 not shown in detail in FIG. 2 are located that is connected via a connecting cable 30.

Various embodiments of the invention will now be described based on this general representation of an electronic throttle control system for a motorcycle.

FIG. 3 shows an electronic throttle control system 32 per a first embodiment example of the invention, consisting of a twist grip 16 and a sensor unit 34. The sensor unit 34 includes a housing 36 and a rotor connector 38 by means of which the twist grip 16 may be attached using a plug connector.

As FIG. 3 shows, the twist grip 16 includes a cable guide ring 40 with a surrounding lip for optional mounting of a classical Bowden cable. The cable guide ring 40 is merely an optional element of the throttle control system 32.

FIG. 4 shows the sensor unit 34 again (separate this time). A rotation sensor to determine the rotational position of the rotor connector unit 38 is located within the housing 36 that is electrically connected via the connector cable 30. The sensor will be described in greater detail in the following.

FIG. 5 shows the design of the sensor unit 34 in exploded view. The two-part housing 36 surrounds a Hall-effect rotation sensor 42 with a stator unit 44 and a rotor unit 46 that may rotate with respect to it.

The rotation position sensor 42 is thus mounted within the rotation axis of the twist grip 16 in the first embodiment example. The rotation axis of the rotor unit 46 coincides with the rotation axis of the twist grip.

Further, a grip coupling unit 48 is also included within the housing into which the twist grip 16 to be plugged to it (see FIG. 3) engages into a non-rotating connection with no free play.

An Oldham coupling 50 is located axially between the rotor unit 46 and the grip coupling unit 48 as an intermediary coupling unit.

The Oldham coupling 50 serves to provide a non-rotating coupling between the grip coupling unit 48 and the rotor unit 46. By means of the special configuration of the Oldham coupling 50, transfer of the rotational motion is ensured between these elements with essentially no free play on the one hand, while on the other hand oblique loads that may arise at the twist grip 16 are transferred to the sensor 42 to a greatly reduced degree, or not at all.

For this, the Oldham coupling 50 includes engagement projections 52a, 52b that are positioned in pairs diametrically opposite each other. Of these, the first engagement projections 52a are so positioned that they project axially in the direction of the grip-coupling unit 48, while second engagement projections 52b are so positioned that they project axially in the direction of the rotor unit 46.

The grip-coupling unit 48 includes corresponding recesses 54 into which the first engagement projections 52a engage with the built-in sensor unit 34. Correspondingly, the rotor unit 46 includes recesses 56 into which the second engagement projections 52b engage.

If oblique forces arise upon the combined sensor unit 34 from the twist grip 16, then they are not transferred further because of the Oldham coupling 50. Instead, a (very minor) tipping motion occurs between the Oldham coupling 50 and the axially adjacent units rotor unit 46 and grip-coupling unit 48. For this, the engagement projections 52a, 52b may move axially to a slight degree within the recesses 54, 56. Thus, transfer of oblique loads is prevented while the rotational motion is transferred with essentially no free play.

FIG. 5 does not show a return element. A return element in any form, such as is explained subsequently in connection with FIG. 14 may be provided at any location of the unit.

FIG. 6 shows the stator unit 44 of the rotation-position sensor 42 that operates on the Hall-effect principle. The stator unit 44 is essentially ring-shaped, and surrounds two stator part elements 58a, 58b shown separately in FIG. 6a that leave open separation recesses 60a, 60b at an angle α of about 120°. The stator part elements 58a, 58b consist of magnetically conducting material, and are embedded in the stator unit 44 made of plastic. The angle thus also determines that the first stator ring element 58a is about 120° and the second stator ring element 58b is about 240° long. In principle, it would be adequate to position one magnetic-field sensor in only one of the separation recesses 60a, 60b forming the air gap. It is preferred to position one Hall-ASIC 62a, 62b in each air gap 60a, 60b connected to a circuit board positioned behind it. The connector cable 30 is connected to the circuit board 64.

The rotor unit 64 shown again separately in FIG. 6b that, as FIG. 5 shows, rotates before the stator unit 44 consists of a ring-shaped magnet mount element 68 onto which a magnet segment element 66 is mounted. The magnet segment element 66 is partial-ring-shaped, is about 120° long, and may be so positioned before both ASICs 60a, 60b that the wrist of the hand holding the twist grip 16 may be moved. Thus, the rotation-position sensor 42 is optimally adapted physiologically.

FIG. 7 shows a sensor unit 70 of a second embodiment example of an electronic throttle control system in exploded view. The sensor unit 70 surrounds an inductive sensor 72 with a rotor unit 75 and a stator unit 76. Since the unit otherwise largely corresponds structurally to the sensor unit 34 per the first embodiment example, consistent reference indices will be used for comparable parts.

As in the first embodiment example, the second embodiment example of the rotation-position sensor 72 is mounted on the rotation axis of the twist grip 16.

As in the first embodiment example, the sensor unit 70 surrounds a grip-coupling unit 48 that is coupled with the rotor unit 74 via a Oldham coupling 50, whereby first and second engagement projections 52a, 52b engage into the recesses 54 on the grip-coupling unit 48 and recesses 56 on the rotor unit 74. Here also, the Oldham coupling 50 fulfilis the function of a non-rotating coupling of the rotor unit 74 at the twist grip 16, whereby oblique forces, however, are not transferred.

An inductive sensor 72 is used in the illustrated sensor unit 70 based on the second embodiment example in which the partial-ring-shaped inductive circuit 80 is mounted on the stator unit 76, and the inductive coupling element 78 is mounted on the rotor unit 74.

An inductive sensor as described in WO-A-2003 038379 is used here. As FIG. 7b shows, the inductor circuit 80 surrounds three inductors 82, 84, 86 formed as conductor strips with spatial structure, and below them are a sine-wave exciter inductor 82, a cosine exciter inductor 84 with displaced phase, and a receptor inductor 86. A so-called “puck,” or resonance circuit consisting of an inductance L and a capacitance C as FIG. 7a shows, moves as an inductive coupling element 78 in front of the inductor circuit 80 as FIG. 7 shows. As is explained in WO-A-2003 038379 in detail, the resonance circuit 78 causes a position-dependent coupling between the two exciter inductors 82, 84 and the receptor inductance 86 so that, upon adequate excitation of the exciter inductors, the phase of the signal induced in the receptor inductor 86 may be evaluated in order to maintain an exact position of the inductive coupling element 78 before the inductor circuit 80.

FIG. 8a, 8b show a perspective view of the front and rear side of a third embodiment example of a sensor unit 90. Although the sensor unit 90 of the third embodiment example are similar in certain respects to the sensor units in the first and second embodiment examples so that consistent reference indices may again be used to comparable units, the third embodiment example is distinguished from the first two in that the rotation sensor used is not positioned on the rotation axis of the twist grip 16, but rather outside it.

As FIG. 9 shows, a ring-shaped engagement element 92 is located with the sensor unit 90 within the housing 36 that is equipped with a toothed section 94 along a part of its circumference. The engagement element 92 is coupled with the twist grip 16 so that it may not rotate, whereby its rotation axis coincides with that of the twist grip 16.

A toothed area 98 is engaged with the toothed area 94 of a sensor shaft 96. The sensor shaft 96 is so positioned within the housing 36 that is mounted so that it may rotate about a rotation axis parallel to the rotation axis of the twist grip 16 and engagement element 92, but at a distance from it. Engagement element 98 and sensor shaft 96 are so coupled via the mutually engaging toothed areas 94, 98 that a rotational motion of the twist grip 16 is transferred to the sensor shaft 96. For this, a return element 100 is mounted on the sensor shaft 96 in the form of a spiral spring mounted about the sensor shaft 96. The spiral spring acts so that the sensor shaft 96 returns against the actuation direction of the twist grip 16. A return moment is created on the sensor shaft 96 by the spiral spring 100 so that the engagement between the toothed areas 94, 98 is not without force, but rather is under tension. This achieves the situation in which the coupling between the engagement element 92 coupled with the twist grip so that it may not rotate and the sensor shaft 96 is without free play so that the rotational position of the twist grip 16 at the sensor shaft 96 may be queried with great exactitude, thus allowing exact throttle control system via the twist grip 16.

FIG. 10 shows the components of the sensor unit 90 in exploded view. Here, engagement elements 92 with toothed area 96 and sensor shaft 96 with toothed area 98 and return spring 100 are shown again. As with the first and second embodiment examples, a grip coupling element 48 is present with a non-rotating connection to the twist grip 16 that is firmly attached via the Oldham coupling 50 to the transfer ring 102 so that it may not rotate. The transfer ring 102 rotates from its side along with the engagement element 92. The Oldham 50 coupling provided to avoid oblique forces is optional for this embodiment example since the sensor 104 is no longer positioned along the rotation axis of the grip 16.

As in the first embodiment example, a Hall-effect rotation-position sensor 104 with a rotor unit 106 and stator unit 108 firmly connected to the sensor shaft 96 is mounted on the sensor shaft 96. The stator 106 includes a partial-ring-shaped magnet element with a length of about 120°. As in the first embodiment example, the stator includes partial-ring-shaped stator segment elements with Hall-effect-ASICs positioned between them that are connected via the connector cable 30.

When a twist grip 16 connected to the grip coupling unit 48 is rotated, its rotation is transferred via the Oldham coupling 50, transfer ring 102, engagement element 92, and toothed areas 94, 98 to the sensor shaft 96 so that the rotor unit 106 rotates with respect to the stator unit 108. The transfer between the toothed areas 94, 98 is without play because of the spring loading via spring element 100. The rotation position of the grip 16 is thus very accurately queried by the rotation-position sensor 104.

In a further embodiment example (not shown), the sensor is mounted outside the rotation axis of the twist grip 16 as in the third embodiment example, but an inductive rotation sensor as described above in connection with FIG. 7 is provided instead of Hall-effect rotation-position sensor shown in FIG. 10.

FIGS. 11, 12, and 13 show a fourth embodiment example of a sensor unit 110. The fourth embodiment example is similar to the third embodiment example shown in FIG. 10, whereby a Hall-effect rotation-position sensor 104 is so mounted on a sensor shaft 96 that its rotation axis extends parallel at a distance from the rotation axis of a twist grip 16. The rotation-position sensor 104 a coupled to the grip 16 via toothed areas 94, 98 so that it may not rotate.

In contrast to the third embodiment example, a pull cable 112 is provided as a return element whose one end is retracted via a spring element 114. A cable guide ring 116 is formed on the sensor shaft 90 to which a second end of the pull cable 112 is attached. Upon rotation of the sensor shaft 96 caused by rotation of the twist grip 16, the pull cable 112 is partially rolled up onto the cable guide ring 116 and received in a guide 117, whereby the pre-tensioned spring 114 is further tensioned. The spring thus acts as a return element on the sensor shaft 96, and causes engagement of the toothed areas 94, 98 with no free play.

While it is possible with both the third and the fourth embodiment example that additional return elements be provided in addition to the return elements 100, 112, 114 on the sensor shaft 96, it is preferred not to use additional return elements, and to use only the shown return elements. Sufficient force for return of the entire system may particularly easily be applied by the spring 114 in the fourth embodiment example.

As above in connection with the illustrated Hall-effect rotation-position sensors, two Hall-effect-ASIC elements may be used for this. FIGS. 14a through 14d show various possibilities of combinations of output signals from two Hall-effect-ASIC elements. For this, the output voltages U₁, U₂ from the two Hall-effect-ASIC elements are shown with respect to rotation angle β. Microcomputers with correction units and software are integrated into the ASICs that may influence the slope and the position of both curves U₁, U₂. This allows the option of influencing the slope of the output voltages U₁ and U₂ individually.

In FIG. 18, the output voltages from the two Hall-effect-ASIC elements are subjected to processing by the unit itself so that the output voltages U₁ and U₂ are identical, and slightly increase dependent on the rotation angle β. Both output voltages are shown under each other for illustration reasons, while the curves actually coincide.

Alternatively, it is possible, as FIG. 14b shows, to obtain output voltages U₁ and U₂ with different slopes between a lower and an upper limit A1, A2.

As a further alternative, FIG. 14c shows that the Hall-effect-ASIC elements may produce voltage signals U₁, U₂ with opposite slopes. For this, the Hall-effect-ASIC elements are positioned rotated by an angle of 180° with respect to each other within each separation recess so that the characteristic curves shown with crosses in FIG. 14c result.

As FIG. 14d shows, the voltage U₁, is converted into a switching signal with the trigger signals regenerated from the limits A1, A2.

The characteristic curves shown in FIGS. 14a through 14d may be used to monitor a particular throttle control system. If, for example, the system supply voltage drops below a value that no longer guarantees system function, an evaluation unit connected to the rotation-position sensor produces monitoring signals corresponding to the software that may be taken into account a necessary.

A large number of modifications are possible to the embodiment examples described. For example, as FIG. 16 shows a cable guide ring 120 may be provided as a return element to which at least a first pull cable 124 and, in a second special, optional configuration, a second pull cable 122 is attached. A first spring 128 or a second spring 130 loads the pull cables 12, 124. The pull cables 122, 124 extend at the cable guide ring within wedge-shaped guide slots 126 so that friction results between the pull cables 122, 124 and the slots 126. The inner sides of the slots consist of a friction-enhancing material that provide resistance to the sliding of pull cables 12, 124. This motion resistance acts upon return of the rotor unit, and leads to a motion hysteresis that may be influenced depending on the configuration of the slot 126 and the type of the friction-enhancing material selected. By selection of the characteristic curves of the springs 128, 130 (e.g., exponential or linear), the system Force/Path characteristic curve may be influenced as desired.

What is claimed is:

1. Electronic throttle control system device for motorcycles that is mounted on a handlebar element, said system comprising, in combination:
a twist-throttle control element that may be adjusted at the handlebar element by rotation along an actuation direction from an idle position to full-throttle position,
a rotation-position sensor that is mounted outside the rotation axis of the twist-throttle control element,
wherein the rotation-position sensor consists of a rotor unit and a stator unit, the rotor unit with the twist-throttle control element may be moved with respect to the stator unit, and the rotation axis of the rotor unit and the twist-throttle control element are positioned parallel to each other at a distance,
and the rotor unit may be adjusted by means of an engagement element connected with the twist-throttle control element that includes a first number of teeth that engage with a second number of teeth on a toothed element,
wherein the toothed element is coupled with the rotor unit, or the rotor unit is at least partially formed as a toothed element,
and at least one return element is provided that acts against the actuation direction so that the engagement between the first and the second teeth is essentially without free play.

2. Device as in claim 1, wherein
the return element is the only return element in the system.

3. Device as in claim 1, wherein
the return element is so pre-tensioned that a spring force acts on the rotor unit even in the idle position.

4. Device as in claim 1, wherein
the return element is a spiral spring that extends around the rotation axis of the rotor unit.

5. Device as in claim 1, wherein
the return element acts via a pull cable on the rotor unit.

6. Device as in claim 1, wherein
the engagement element is mounted within the rotation axis of the twist-throttle control element, and rotates with it, and
wherein an axial bearing is provided for the engagement element.

7. Electronic throttle control system for motorcycles that is mounted on a handlebar element, said system comprising, in combination:
a twist-throttle control element that may be adjusted at the handlebar element,
a rotation-position sensor that consists of a rotor unit and a stator unit,
wherein the rotor unit may be moved rotationally by means of the twist-throttle control element with respect to the stator unit,
wherein the rotation-position sensor is mounted axially adjacent to the twist-throttle control element, and the rotation axis of the rotor unit essentially coincides with the rotation axis of the twist-throttle control element,
whereby wherein an intermediary coupling unit is provided axially between the twist-throttle control element and the rotor unit that is firmly connected with both the twist-throttle control element and the rotor unit so that it may not rotate, but that does not transmit any occurring oblique forces.

8. Device as in claim 7, wherein
the intermediary coupling unit is essentially disk-shaped with axial engagement projections,
wherein at least two engagement projections engage into recesses of the rotor unit and of the twist-throttle control element or of an element connected with the twist-throttle control element so that they may be axially displaced.

9. Device as in claim 1, wherein
a return element is formed by at least one spring-loaded pull cable that is attached to an essentially ring-shaped cable guide ring element,
the cable-guide ring element is coupled with the rotor unit or with the twist-throttle control element so that it may not rotate,
whereby wherein the cable-guide ring element includes a cable guide slot formed with at least a partial wedge-shaped cross-section into which the pull cable is (122, 124) fed.

10. Device as in claim 7, wherein
a return element is formed by at least one spring-loaded pull cable that is attached to an essentially ring-shaped cable guide ring element,
wherein the cable guide ring element is coupled with the rotor unit or with the twist-throttle control element so that it may not rotate,
wherein the cable-guide ring element includes a cable guide slot formed with at least a partial wedge-shaped cross-section into which the pull cable is fed.

11. Device as in claim 1, wherein
the rotation-position sensor is formed as a Hall-effect rotation sensor element,
wherein a magnet element is mounted on the rotor unit,
and the stator unit consists of two opposing partial stator elements that have at least one separation recess wherein at least one Hall-effect element is mounted in at least one separation recess.

12. Device as in claim 7, wherein
the rotation-position sensor is formed as a Hall-effect rotation sensor element,
wherein a magnet element is mounted on the rotor unit,
and the stator unit consists of two opposing partial stator elements that have at least one separation recess, wherein at least one Hall-effect element is mounted in at least one separation recess.

13. Device as in claim 11, further comprising
a stator ring element 100° to 140° long
and a second stator ring element 220° to 260° long.

14. Device as in claim 12, further comprising
a stator ring element 100° to 140° long,
and a second stator ring element 220° to 260° long.

15. Device as in claim 11, wherein
the rotor unit surrounds a partial-ring-shaped magnet segment element with a length of 100° to 150° that is mounted on a magnet mount element.

16. Device as in claim 12, wherein
the rotor unit surrounds a partial-ring-shaped magnet segment element with a length of 100° to 150° that is mounted on a magnet mount element.

17. Device as in claim 1, wherein
the rotation-position sensor is formed as an inductive rotation sensor,
wherein an induction circuit with at least two inductors are mounted on the stator unit,
and an inductive coupling element is provided on the rotor unit for position-dependent inductive coupling of the two inductors is provided.

18. Device as in claim 7, wherein
the rotation-position sensor is formed as an inductive rotation sensor,
wherein an induction circuit with at least two inductors are mounted on the stator unit,
and an inductive coupling element is provided on the rotor unit for position-dependent inductive coupling of the two inductors is provided.

19. Device as in claim 17, wherein
the induction circuit is partial-ring-shaped and has a length of 100 to 140°.

20. Device as in claim 18, wherein
the induction circuit is partial-ring-shaped and has a length of 100 to 140°.

21. Device as in claim 17, wherein
the inductive element is configured as a resonance circuit with at least one inductor and one capacitor.

22. Device as in claim 18, wherein
the inductive element is configured as a resonance circuit with at least one inductor and one capacitor.

23. Electronic throttle control system for motorcycles that is mounted on a handlebar element (12), said system comprising, in combination:
a twist-throttle control element that may be adjusted at the handlebar element,
a rotation-position sensor that consists of a rotor unit and a stator unit, wherein the rotor unit may be moved rotationally by means of the twist-throttle control element with respect to the stator unit, and
at least one spring element by means of which at least the twist-throttle control element may be returned,
wherein the rotation-position sensor is mounted adjacent to the twist-throttle control element and the rotor unit is adjusted by means of a drive setting element connected with the twist-throttle control element component element,
and wherein the stator unit consists of two opposing partial stator elements that have at least one separation recess, wherein at least one Hall-effect element is mounted in at least one separation recess,
whereby wherein a first stator ring element (58a) has a length of 100 to 140°,
and a second stator ring element 220° to 260° long is provided.

24. Device as in claim 23, wherein
the rotor unit surrounds a partial-ring-shaped magnet segment element with a length of 100° to 150° that is mounted on a magnet mount element.

25. Electronic throttle control system for motorcycles that is mounted on a handlebar element, said system comprising, in combination:
a twist-throttle control element that may be adjusted at the handlebar element,
a rotation-position sensor that consists of a rotor unit and a stator unit, wherein the rotor unit may be moved rotationally by means of the twist-throttle control element with respect to the stator unit,
at least one spring element by means of which at lest the twist-throttle control element may be returned,
wherein the rotor unit is adjusted by means of a drive setting element connected with the twist-throttle control element,
wherein the rotation-position sensor is formed as an inductive rotation sensor,
wherein an inductive coupling element is provided on the rotor unit, and an induction circuit with at least one exciter inductor and one receptor inductor mounted on the stator unit,
wherein the inductive coupling element causes a position-dependent coupling between the exciter inductors and the receptor inductance, and
wherein the induction circuit is partial-ring-shaped and extends over an angle range of 100°-140°.

26. Device as in claim 25, wherein
the inductive coupling element is configured as a resonance circuit with at least one capacitor (c) and one inductor (L).
